(19) United States
(12) Patent Application Publication
(10) Pub. No.: US 2007/0214305 A1
(43) Pub. Date: Sep. 13, 2007

(54) Storage device with a native RJ-45 connector

(75) Inventor: Itzhak Levy, Hollywood, FL (US)

Correspondence Address: LERNER GREENBERG STEMER LLP, P O BOX 2480, HOLLYWOOD, FL, 33022-2480, US

(73) Assignee: Arco Computer Products, LLC

(21) Appl. No.: 11/369,390

(22) Filed: Mar. 7, 2006

(51) Int. Cl. G06F 13/36

(52) U.S. Cl. 710/315

(57) ABSTRACT

A computer storage device has a RJ-45 female connector. In this RJ-45 physical storage device, the RJ-45 connector is integrated into the storage device control unit. This eliminates the need for a hardware bridge between the serial or parallel ATA/ATAPI/SCSI/SAS/Fiber Optic or any other storage device and a computer or computer network.

### BACKGROUND OF THE INVENTION

### Field of the Invention

The invention lies in the computer technology field. More specifically, the invention relates to a storage device for the computer industry.

The personal computer revolution of the early 1980's created a need for data storage devices with the ability to read/write and modify data as needed by the computer applications. Before the personal computer revolution, data was saved on magnetic ring units that occupied a large space and had a limited capacity and very low performance levels.

With the personal computer revolution, the market demanded a larger storage capacity and more compact sized storage device that could be connected to the computer. The first Personal Computer (PC) that was produced by IBM (International Business Machine) in the early 1980's supported a 5.25″ floppy disk with a limited storage capacity and very poor performance. At the time it was the height of technology.

With the release of the IBM XT, the first Hard File Device—a ST506 5.25″ 10 MB Disk—was introduced in the personal computer market. As software applications began to require more and more storage space and a faster data transfer rate between the computer and the storage device, the computer industry faced a challenge of supplying faster and higher capacity storage devices.

The computer industry has introduced various types of storage devices such as hard disks, tape drives, optical disks, CD ROMs, DVD players, removable media (floppy drives, Zip drive) with various types of interface formats (ST506, ESDI, IDE, EIDE, ATA, SATA, SCSI, SAS) with the goal of being faster, higher-capacity and more affordable to the user.

Over time, the computer industry settled on the two common mostly used interfaces: SCSI and ATA/ATAPI. The SCSI interface (Small Computer System Interface) has long been considered the highest performance and highest capacity drive interface. For this reason, SCSI disks are used for high performance systems such as servers and workstations. The ATA/ATAPI (Advance Technology Attachment Protocol Interface) interface is a less expensive alternative to the SCSI interface, with a lower performance levels adequate for the personal desktop computer market as well as other moderately sized computer systems (POS, medical equipment, web server, etc.). Over time, the ATA/ATAPI storage devices interface has improved to close the gap in performance and capacity with the SCSI interface storage devices.

The early SCSI devices were supported by 50 pin connectors and the ATA/ATAPI by 40 pin connectors. Both storage types are connected via a flat cable to the host computer system. This type of connection is known as parallel connection. The flat parallel cable connection limits the use of these storage devices to internal use due to the limited recommended cable lengths and the complexity of delivering several signals at once.

To overcome some of the problems caused by the flat cable, (noise, cable length, space, speed of data transfer, air flow limitation, etc.) the computer industry recently introduced the SATA (Serial Advanced Technology Attachment) and the SAS (Serial Attachment SCSI), two new interface formats that transfer data through serial connection but follow the same protocols required by ATA/ATAPI and SCSI interfaces respectively. The protocol compatibility is necessary to allow the existing operating systems and software applications to be compatible with the new storage devices without the need for any software modification. This compatibility allowed the industry to quickly and easily adapt to the new serial interface technologies.

The desired sharing of data and the increase of a local network at work place and homes started a new category of external devices called Network Attached Storage (NAS). A network-attached storage (NAS) device is dedicated to nothing more than file sharing. A NAS device does not need to be located within the server but can exist anywhere in a LAN.

It is a safe prediction that networks will always be short of storage capacity. As a clients' storage grow, so do the volumes of data they want to store locally and share on a central server. For a small or medium size business adding storage to a server to keep user happy is a tiresome and often-time consuming business. Far easier, is to buy a network attached storage (NAS) appliance that simply plugs into the network with a minimum setting. In fact this easy of use combined with the dropping cost of storage means that NAS has grown to become a very popular hardware category.

In today's market, one of the most widely used connections to a network is via the so-called RJ-45 connector. The protocol communication of the attached device can be any given protocol and it should not be used as a limitation to this invention.

In order to use an ATA/ATAPI/SCSI or any other storage device as a NAS device, a bridge between the storage device and the network port (RJ-45) is needed. The industry quickly filled this need by developing hardware to serve as the bridge to convert the storage devices signals interface to a RJ-45 connector with the desired protocol. There is a tremendous market for NAS devices that connect to the network in this fashion.

### SUMMARY OF THE INVENTION

It is accordingly an object of the invention to provide a native storage device with a RJ-45 connector integrated into the storage device control unit to support a direct connection to a computers network without any limitation to any type of network protocol. This eliminates the need for a hardware bridge between the storage devices and any RJ-45 network port.

With the foregoing and other objects in view there is provided, in accordance with the invention, a computer storage device assembly, comprising:

a computer storage device;

a control unit connected to the computer storage device for reading data from the storage device; and

at least one native RJ-45 connector configured for receiving an RJ-45 connecting the control unit to a host computer or a computer network.

In accordance with an added feature of the invention, the storage device is a read and write capable device.

In accordance with a preferred feature of the invention, the storage device is a device with ATA/ATAPI/SCSI/SAS or any other protocol interface communication. That is, the storage device is a device with any protocol interface communication. The protocol type does not have any significant meaning within this invention and should not be understood as a limitation.

With the above and other objects in view there is also provided, in accordance with the invention, a computer hard disk drive assembly, consisting essentially of a hard disk, a control unit connected to the hard disk, a power connector, and at least one a RJ-45 female connector configured to receive a RJ-45 male connector for connection to a host computer and or a computer network. Preferably, the assembly is configured as a computer-internal disk drive and dimensioned for installation in any type or form of a drive bay.

In accordance with an alternative embodiment of the invention, there is provided an external hard drive assembly, consisting essentially of a computer storage device, a control unit connected to the storage device, a housing enclosing the storage device and the control unit, a power connector mounted to the housing, and at least one RJ-45 connector mounted to the control unit and configured to receive a RJ-45 male connector for connecting the control unit to a host computer and or computer network.

In accordance with a concomitant feature of the invention, the computer storage device is a hard disk drive device, a CD ROM, and/or a DVD.

### BRIEF DESCRIPTION OF THE DRAWING

FIG. 1 shows a storage device.

FIG. 2 shows the storage device controller unit with electronics components assembled on a PCB.

FIG. 3 shows a parallel ATA/ATAPI (PATA) storage device.

FIG. 4 shows a serial ATA/ATAPI (SATA) storage device.

FIG. 5 shows a RJ-45 Modular Jack Female and Male.

FIG. 6 shows RJ-45 Modular Wiring Reference.

FIG. 7 shows an Ethernet bridge that connects any giving storage device interface signals to a RJ-45 connection signals and vice versa.

FIG. 8 shows a parallel ATA/ATAPI storage device connected via a RJ-45 connector mounted on a bridge to a computer network.

FIG. 9 shows the invention, a storage device integrated with a control unit that includes a RJ-45 connector connected to a computer network.

FIG. 10 shows a storage device enclosed in an external enclosure with a RJ-45 connector that connected to a computer network via the RJ-45 connector.

### DESCRIPTION OF THE PREFERRED EMBODIMENTS

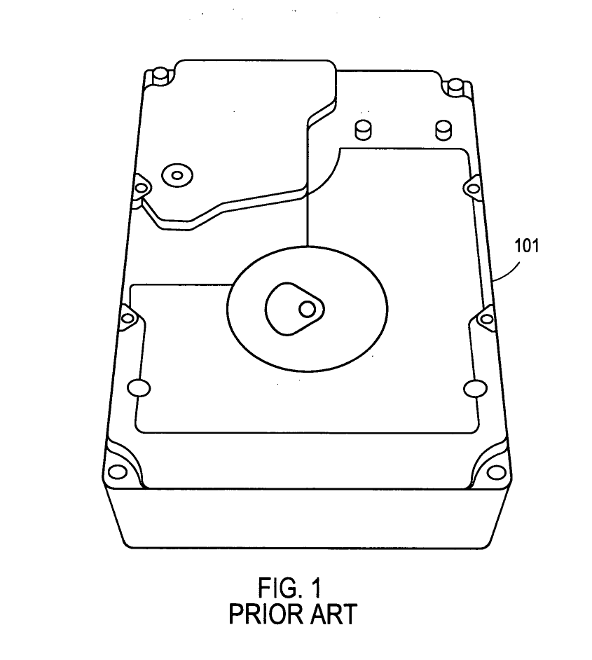

Referring now to the figures of the drawing in detail, FIG. 1 shows a bare storage device 101 without any electronics attached to it. The storage device described in this figure can be a Heads Disk Assembly (HDA) or and type of removable storage device such as a CD-ROM, DVD, tape drive, etc. The figure shows an HDA device that includes magnetic platters, heads and a servo motor protected by a vacuum sealed package to avoid damage from dust and to achieve high speed rotation of the platters. The faster the rotation of the platters, the faster data can be transferred between the HDA, the control unit and the host computer.

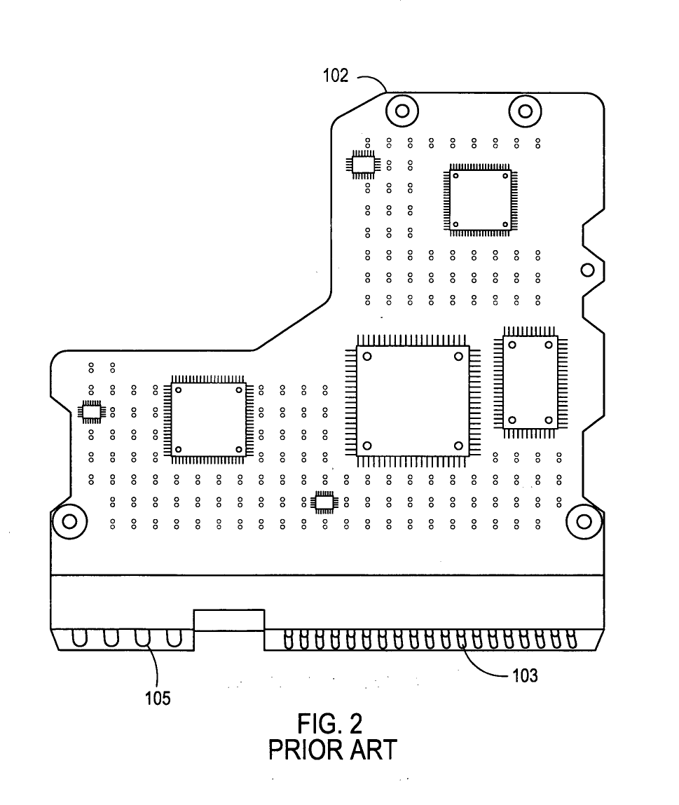

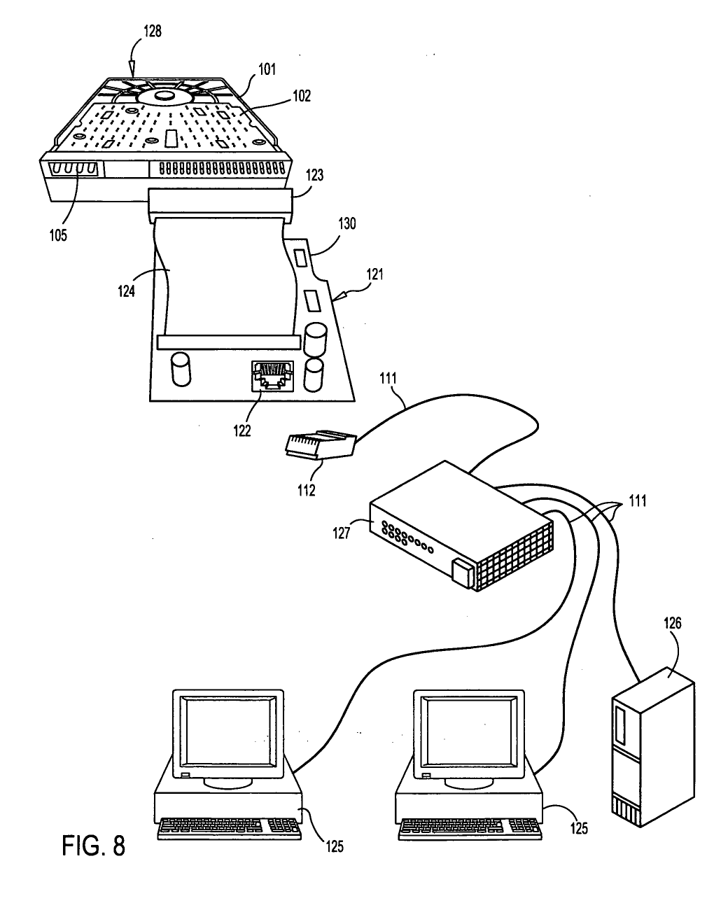

FIG. 2 shows a PCB with electronics forming the Control Unit 102 that includes all components needed to control the storage device 101 for the purpose of transferring data in and out of the storage device 101. The control unit 102 also includes a 40 pin (male) interface connector 103 (Parallel ATA/ATAPI) that is connected via a 40 pin cable 124 (shown at FIG. 8) to the host computer, and a power connector 105 for receiving the power needed to power the control unit 102 and the storage device 101. The control unit 102 can be with any type of interface connection. FIG. 2 shows the 40 pin signal interface connection 103 without any intention of limitation on the storage device interface.

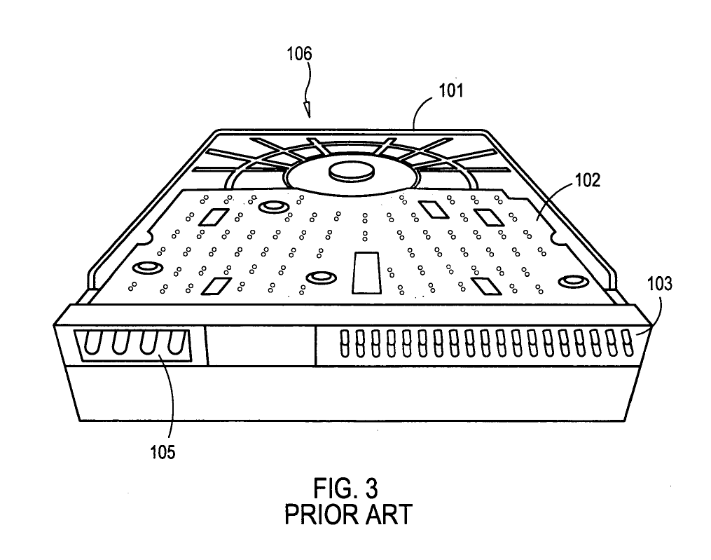

FIG. 3 shows a storage device 101 integrated with a control unit 102 forming a parallel ATA/ATAPI storage device 106 with a 40 pin signal interface connector 103 and the legacy power connector 105.

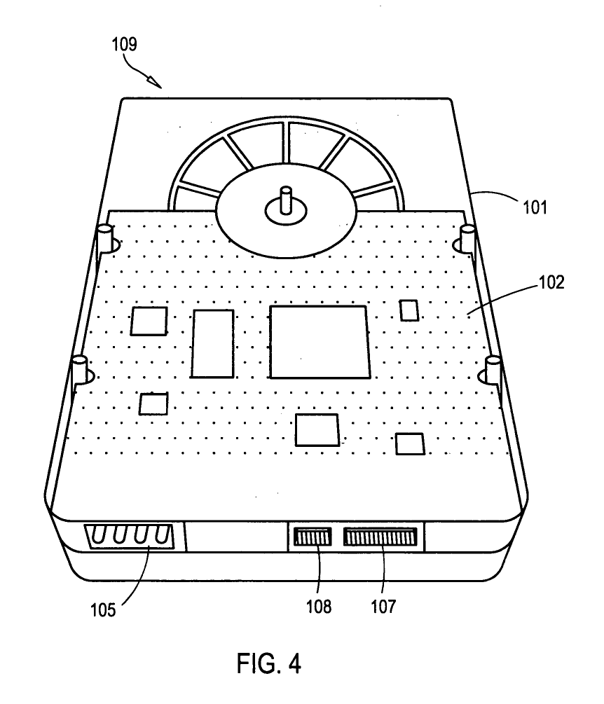

FIG. 4 shows a storage device 101 integrated with a control unit 102 forming a serial ATA/ATAPI storage device 109 with a serial ATA interface connectors 107, 108 that includes the data and power signals and the legacy power connector 105. The reason for this serial ATA/ATAPI storage device 109 having both types of power connectors is for compatibility purposes only. Only one of the power connectors is actually required for operation at any given time.

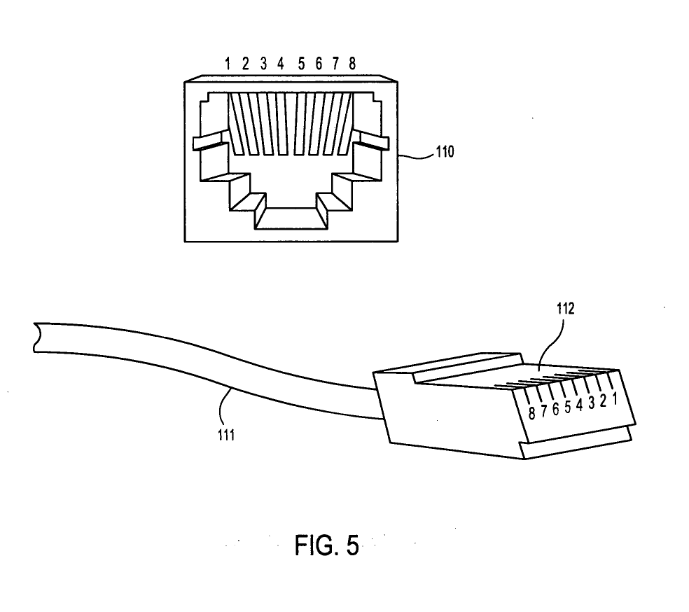

FIG. 5 shows a RJ-45 Modular Jack Female 110 and RJ-45 Modular Jack Male 112 connected to a twisted-pair cable 111.

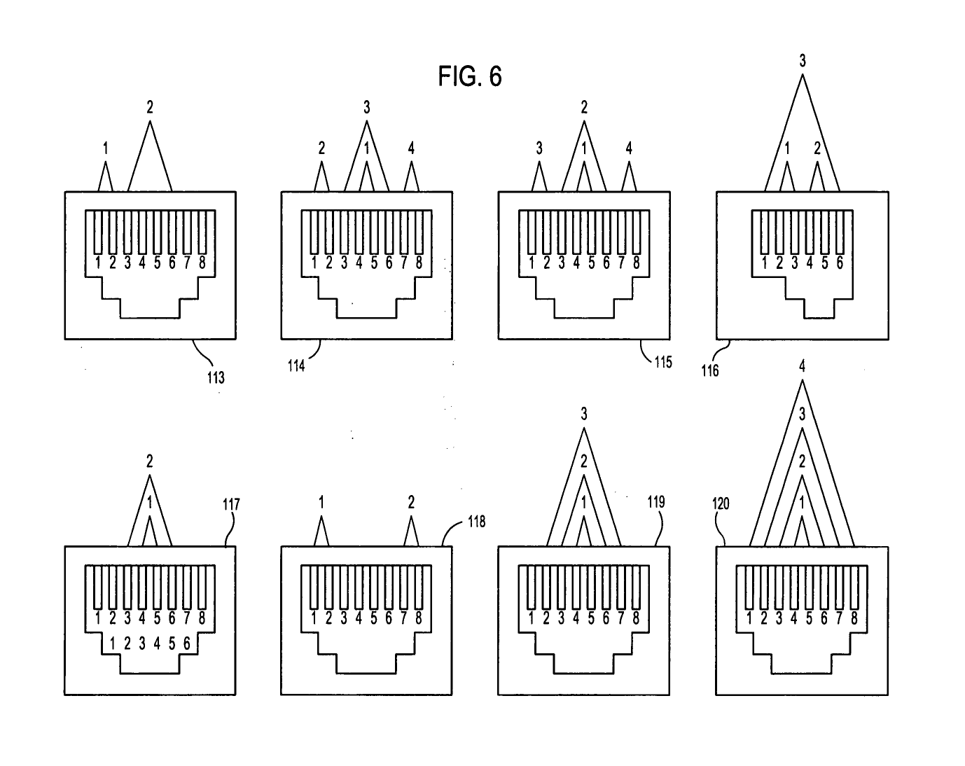

FIG. 6 shows the Modular Wiring Reference as follow:

1. 10BASE-T (802.3) 113

2. 568B Wiring 114

3. 568A Wiring 115

4. MMJ Wiring 116

5. Token Ring (802.5) 117

6. TP-PMD (X3T9.5) 118

7. USOC 3 Pair 119

8. USOC 4 Pair 120

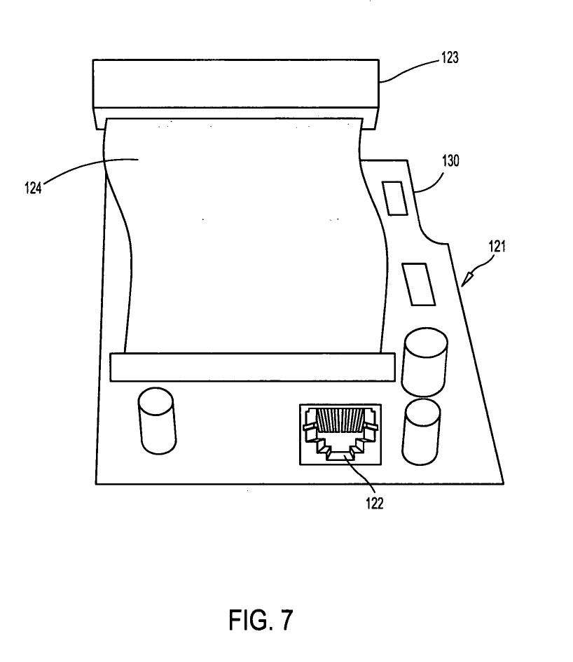

FIG. 7 shows an Ethernet bridge 121 that includes a PCB 130 which includes the electronics components, a RJ-45 female connector 122 a 40 pin flat cable 124 with a 40 pin (female) connector 123.

FIG. 8 shows a complete assembly of a parallel ATA 106 and an Ethernet bridge 121 to form a storage device to be connected to a computer or computer network via a RJ-45 connector 122. This Figure also shows a twisted-pair cable 111 that connects at one end to the RJ-45 connector 122 on the Ethernet bridge 121 and at the other end to the computer network 127 to allow data transfer between the parallel ATA Disk 106 and the network computer system.

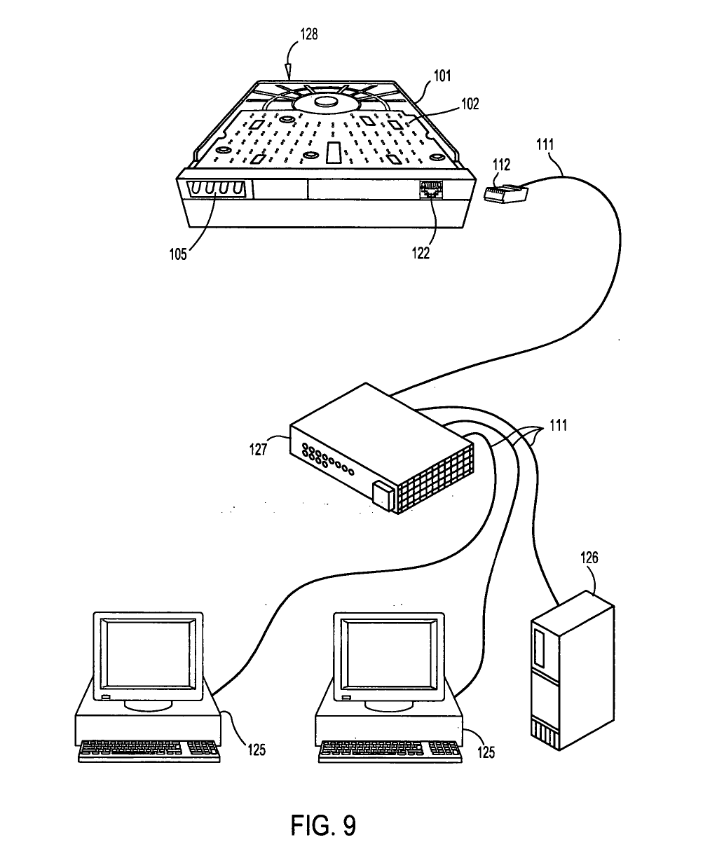

FIG. 9 shows the invention that includes a storage device 101 with a control unit 102 that integrates a RJ-45 modular jack female connector 122 forming a native RJ-45 storage device 128. The native RJ-45 storage device 128 will generate data in any protocol that use the RJ-45 connector as a mean to transmit/receive data via the twisted-pair and the RJ-45 connectors.

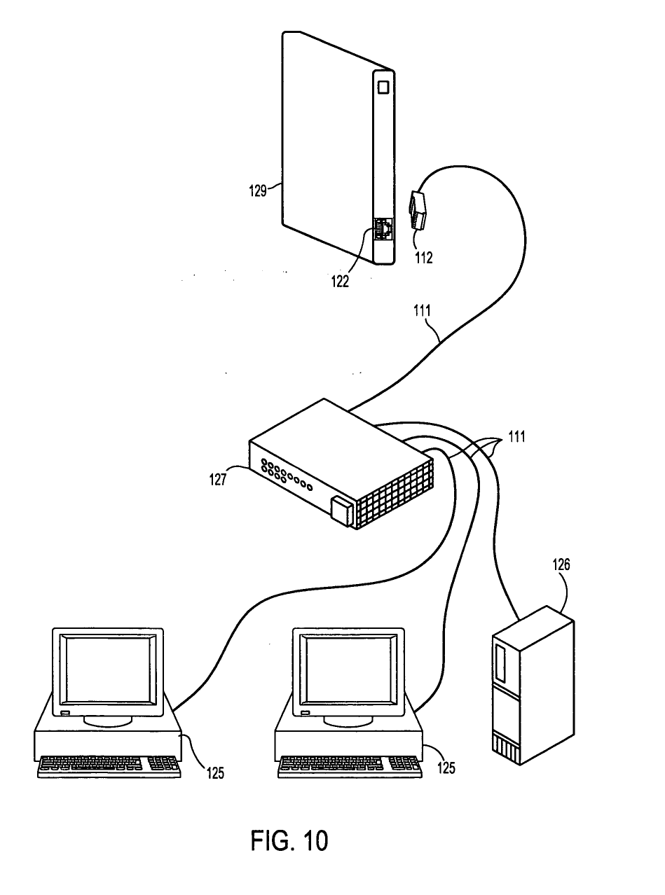

FIG. 10 shows an external storage device in an external enclosure 129 that contains the invention: a native storage device with RJ-45 connector 128 that is connected to the network computer 127 via a twisted-pair cable 111.

I consider herein two distinct implementations of the novel configuration, namely:
The “bridge component” and the RJ-45 connectors may be integrated on the storage device control unit; or
a new set of components can include, without a limitation, an ASIC (application specific IC) device to be configured and/or assembled to support the storage device heads, the motor and data transfer via a RJ-45 connector, thereby supporting any desired transfer protocol.

The term “native” as used herein should be understood to include these implementations.

Those of skill in the pertinent art will be familiar with the RJ-45 plug and socket cable specification and pin assignment. Two wiring standards are conventional for the RJ-45, namely, the T-568A and the T-568B designations. In terms of color, the RJ-45 uses four pairs, namely, orange, green, blue, and brown (one solid, one striped). In that regard, it will be understood that the above-noted pin assignment may be varied within the conceptual boundaries of the invention and that one or several of the pin assignments may be exchanged, replaced with a different standard, or omitted altogether.

I claim:

1. A computer storage device assembly, comprising:
a computer storage device;
a control unit connected to said computer storage device for reading data from said storage device; and
at least one RJ-45 socket connector configured for receiving an RJ-45 plug connector for connecting said control unit to a computer or a network.

2. The assembly according to claim 1, wherein said storage device is a read and write capable device, and said control unit is configured to read from and write to said storage device.

3. The assembly according to claim 1, wherein said storage device is a device with any protocol interface communication.

4. A computer hard disk drive assembly, consisting essentially of a hard disk, a control unit connected to said hard disk, a power connector, and at least one female RJ-45 connector configured to receive a twisted-pair cable for connection to a host computer or network computer.

5. The assembly according to claim 4 configured as a computer-internal disk drive and dimensioned for installation in any type of drive bay.

6. An external hard drive assembly, consisting essentially of a computer storage device, a control unit connected to said storage device, a housing enclosing said storage device and said control unit, a power connector mounted to said housing, and at least one RJ-45 connector and configured to receive a twisted-pair cable for connecting said control unit to a host computer or a network.

7. The assembly according to claim 6, wherein said computer storage device is a hard disk drive device.

8. The assembly according to claim 6, wherein said computer storage device is a storage device selected from the group consisting of a hard disk, a CD ROM, and a DVD.
